(19) United States
(12) Patent Application Publication
(10) Pub. No.: US 2003/0078011 A1
(43) Pub. Date: Apr. 24, 2003

(54) Method for integrating a plurality of radio systems in a unified transceiver structure and the device of the same

(75) Inventors: Jui-Hsi Cheng, Hsinchu (TW); Tsung-Liang Lin, Hsinchu (TW)

Correspondence Address: BAKER & McKenzie, James D. Jacobs, 29th Floor, 805 Third Avenue, New York, NY, 10022, US

(73) Assignee: Integrated Programmable Communications, Inc.

(21) Appl. No.: 10/200,168

(22) Filed: Jul. 23, 2002

Related U.S. Application Data
(60) Provisional application No. 60/330,362, filed on Oct. 18, 2001.

(51) Int. Cl. H04B 1/38

(52) U.S. Cl. 455/73; 455/84

(57) ABSTRACT

A preferred embodiment of the invention advantageously provides a method for integrating a plurality of radio systems in a unified transceiver structure and the device of the same. According to this general embodiment of the invention, all components for the necessary communication protocols of a device are determined by selecting the operation ranges of the components and designing a mechanism to adjust the operation parameters of the shared components for conforming to the utilized communications system. Therefore, only one radio frequency (RF) module is required for a communications device having a plurality of communication systems. An end user can advantageously carry a single and compact wireless device for various communications systems.

### RELATED APPLICATIONS

The present patent application relates to, and claims priority of, U.S. Provisional Patent Application Serial No. 60/330,362 filed on Oct. 18, 2001, which is incorporated herein by reference.

### BACKGROUND OF THE INVENTION

1. Field of the Invention

The invention generally relates to wireless communications and, more particularly, to a method for integrating a plurality of radio systems in a unified transceiver structure and the device of the same.

2. Description of the Related Art

Spread spectrum is a primary technology in wireless communications having particular applications in the art for its resistance to interference, jamming and background noise. Two methods, direct sequence and frequency hopping, are commonly employed in spread spectrum. For example, a wireless local area network (WLAN) uses direct sequence for spread spectrum, whereas Bluetooth™ employs frequency hopping.

Owing to limitation of frequency resources, a shortcoming in the art for wireless communication systems is the co-existence of multiple communication standards in the same radio bands (e.g., WLAN and Bluetooth™ in the 2.4 GHz ISM radio band). While WLAN and Bluetooth™ have their own advantages in their respectively designated communications targets, it is a major shortcoming in the art if no single device can support these two systems. However, this single device still requires multiple radio frequency (RF) modules to support these two systems. FIG. 1 is a schematic view illustrating such a transceiver structure with a separate receiver and transmitter in the art, which requires multiple RF modules, each having its own antenna and transmitter/receiver (TX/RX) structures.

There is therefore a general need in the art for a method and system overcoming at least the aforementioned shortcomings in the art. In particular, there is a need in the art for a system and method supporting these two WLAN and Bluetooth™ systems in one single device using a single RF module.

### SUMMARY OF THE INVENTION

A preferred embodiment of the invention accordingly provides a method for integrating a plurality of radio systems in a unified transceiver structure and the device of the same. According to this particular embodiment of the invention, all components for the necessary communication protocols of a device are determined by selecting the operation ranges of the components and designing a mechanism to adjust the operation parameters of the shared components for conforming to the utilized communications system. Therefore, only one radio frequency (RF) module is required for a communications device having a plurality of communication systems. An end user can advantageously carry a single and compact wireless device for various communications systems.

The invention further provides a method for integrating a plurality of radio systems, each being conformed to a communications mode into one communications module. Each of the communications modes utilizes a different communications protocol. The communications module according to this particular embodiment of the invention further comprises a radio frequency (RF) transceiver, a baseband system comprising a dedicated circuit, a processor, a controller or the combinations thereof. A preferred embodiment of the method according to the invention comprises the steps of selecting and programming each of the components in the transmitter and receiver to be suitably operative in a plurality of radio systems, programming the baseband system to control the transmitter and the receiver in response to a selected radio system out of the plurality of radio systems, and determining a communications mode out of a plurality of communications modes in response to the selected radio system for operating the RF transceiver. A further embodiment of the invention provides a method for integrating a plurality of radio systems in a unified transceiver structure having a transceiver operative in a plurality of communications modes. The method according to this particular embodiment comprises the steps of transmitting and receiving signals respectively using a transmitter and a receiver, filtering the transmitted signals and the received signals, respectively blocking and suppressing out-of-band signals of the received signals and the transmitted signals, selecting an operative radio system out of the plurality of radio systems, programming the transceiver for controlling the transmitter and the receiver in response to the selected operative radio system, selecting components in the transmitter and the receiver for operation thereof in response to the selected operative radio system, and selecting an operative communications mode out of the plurality of communications modes in response to the selected operative radio system for operating the transceiver.

Another preferred embodiment according to the invention provides a unified transceiver structure having a transceiver operative in a plurality of communications modes. According to this particular embodiment of the invention, the unified transceiver structure comprises a plurality of radio systems, a transmitter and receiver respectively transmitting and receiving signals, and a bandpass filter respectively blocking and suppressing out-of-band signals of the transmitted and received signals, wherein an operative radio system is selected out of the plurality of radio systems. The unified transceiver structure further provides a baseband system programming the transceiver for controlling the transmitter and receiver, and selecting components in the transmitter and receiver for operating the transceiver, in response to the selected operative radio system, and a mode selector selecting an operative communications mode out of the communications modes in response to the selected operative radio system for operating the transceiver.

Another embodiment of the invention provides a communications device for integrating a plurality of radio systems into a single communications module having a plurality of communications modes, where each of the plurality of radio systems is conformed to a corresponding communications mode out of the plurality of communication modes. Each communications mode includes a corresponding communication protocol. The communications module according to this embodiment of the invention primarily comprises an antenna for receiving and transmitting signals, a bandpass filter connected to the antenna for blocking unwanted out-of-band received signals and suppressing unwanted out-of-band transmitted signals and a switch connected to the bandpass filter through which transmitted and received signals are passed. The communications module according to the invention operates in a receiving mode as the received signals pass through the bandpass filter. When the transmitted signals pass through the switch, the communications module operates in a transmitting mode. The switching time for the switch should be the shortest among all communications modes.

A communication system according to another embodiment of the invention further comprises a radio frequency (RF) transceiver connected to the switch. The RF transceiver comprises a receiver and a transmitter. The receiver is connected to the switch and comprises a plurality of amplifiers, at least one filter component and at least one down-converting component. Once an operative radio system is selected from the plurality of radio systems, each of the components in the receiver is accordingly selected for suitable operation in response to the selected operative radio system. The transmitter of the transceiver according to this particular embodiment of the invention is connected to the switch and comprises a plurality of amplifiers, at least one filter component and at least one up-converting component. As an operative radio system is selected from the plurality of radio systems, each of the components in the receiver is accordingly selected for suitable operation in response to the selected operative radio system. In addition, the communication system according to the invention can further comprise an interface connected to the RF transceiver and utilized to for digital-to-analog and analog-to-digital signal conversion. Moreover, the communication system can further comprise a baseband system connected to the interface for controlling the transmitter and receiver in response to the selected operative radio system.

### BRIEF DESCRIPTION OF THE DRAWINGS

FIG. 1 is a schematic view illustrating a transceiver structure with a separate receiver and transmitter in the art;

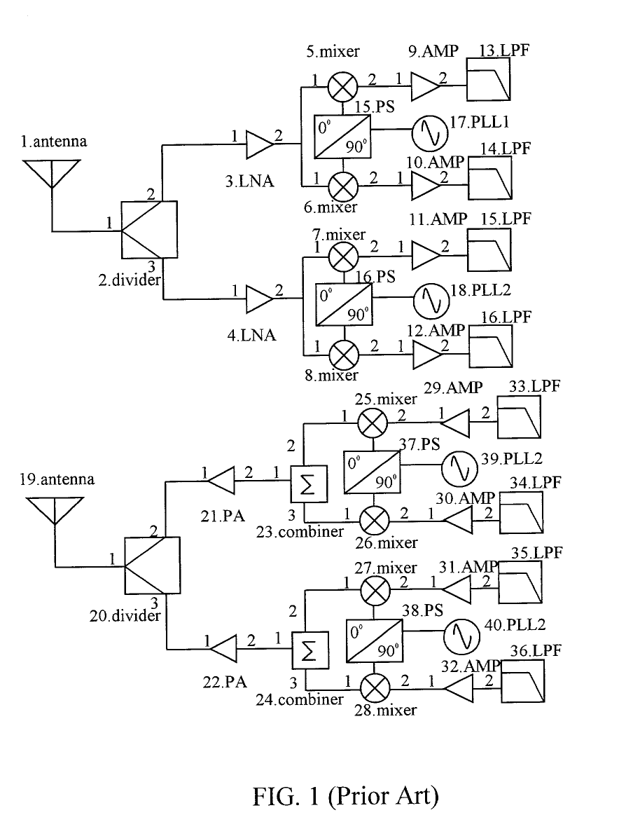

FIG. 2 is a schematic view generally illustrating various sections of a transceiver structure according to an embodiment of the invention; and

FIG. 3 is another schematic view illustrating a multi-mode transceiver structure according to a preferred embodiment of the invention.

### DETAILED DESCRIPTION OF PREFERRED EMBODIMENTS

For better understanding of the invention for those skilled in the art, a detailed description thereof is provided herein and below. However, the following description and appended drawings are only used to cause those skilled in the art to better understand the advantages, objects, features, and characteristics of the invention, but not to confine the scope and spirit of the invention as defined in the appended claims and their equivalents.

The invention generally provides a method for integrating a plurality of radio systems in a unified transceiver structure and the device of the same. According to a general embodiment of the invention, all components for the necessary communication protocols of a communications device are determined by selecting the operation ranges of the components and designing a mechanism to adjust the operation parameters of the shared components for conforming to the utilized communications system. Therefore, only one radio frequency (RF) module is required for a communications device having a plurality of communication systems. An end user can advantageously carry a single and compact wireless device for various communications systems.

A preferred embodiment of the invention provides a method for integrating a plurality of radio systems in a unified transceiver structure having a transceiver operative in a plurality of communications modes. The method according to this particular embodiment comprises the steps of transmitting and receiving signals respectively using a transmitter and a receiver, filtering the transmitted signals and the received signals, respectively blocking and suppressing out-of-band signals of the received signals and the transmitted signals, selecting an operative radio system out of the plurality of radio systems, programming the transceiver for controlling the transmitter and the receiver in response to the selected operative radio system, selecting components in the transmitter and the receiver for operation thereof in response to the selected operative radio system, and selecting an operative communications mode out of the plurality of communications modes in response to the selected operative radio system for operating the transceiver. In further embodiments of the method according to the invention, the received signals are converted into baseband signals in I and Q channels. Moreover, the baseband signals are phase locked, and their corresponding frequencies respectively controlled. The channel bandwidths of the baseband signals in the I and Q channels. In addition, alias signals from the baseband signals in the I and Q channels that are outside the Nyquist frequency are rejected, and their corresponding variable gain respectively controlled. The baseband signals are digitized for further processing in a baseband system.

In operating the unified transceiver structure in accordance with the invention, the transmitter and the receiver can be switched back and forth. According to an embodiment of the invention, a shortest switching time is particularly selected in switching between the transmitter and receiver. In an additional embodiment of the method according to the invention, in-band gain reduction is advantageously prevented by controlling the variable gain of, and rejecting alias signals from, the baseband signals in the I and Q channels, respectively. In addition, the operation of the transceiver is conformed to the selected operative radio system by respectively selecting channel bandwidths for, controlling a variable gain of, and rejecting alias signals from the baseband signals in the I and Q channels. Another embodiment of the method according to the invention further comprises the step of tuning a hopping rate for the selected operative communications mode. A hopping channel can also be programmed for the selected operative communications mode. Furthermore, a locally oscillating (LO) settling time for the baseband signals in the I and Q channels can be accordingly designated in response to the hopping rate of the selected operative communications mode. Yet another embodiment of the method according to the invention further comprises the step of maintaining a desired transmission output power level for the selected operative communications mode. Moreover, a shortest locally oscillating (LO) settling time for the baseband signals in the I and Q channels for maintaining a desired transmission output power level for the selected operative communications mode. An additional embodiment of the method of the invention further comprises the step of adjusting a burst shape of the baseband signals in the time domain. Furthermore, in adjusting the burst shape, the rising and falling time, overshoots and damping thereof can also be controlled accordingly.

The method according to another embodiment of the invention further comprises the steps of converting the transmitted signals into baseband signals in an I channel and a Q channel, of respectively reconstructing the baseband signals in the I and Q channels, respectively rejecting out-of-channel signals from the baseband signals in the I and Q channels, and respectively controlling channel bandwidths for the I and Q channels, of the baseband signals. The method according to yet another embodiment of the invention further comprises the steps of respectively up-converting the baseband signals in the I and Q channels into radio frequency (RF) signals, separating the baseband signals into in-phase signals and quadrature phase signals, and radio frequency (RF) combining the in-phase the quadrature phase signals, controlling the variable gain of the baseband signals in the I and Q channels. The method according to an additional embodiment of the invention further comprises the steps of bandpass filtering the baseband signals in the I and Q channels, power amplifying the filtered baseband signals, detecting the RF power level of the amplified baseband signals, converting the RF power level into a direct current (DC) voltage, and monitoring the output power of the amplified baseband signals using the DC voltage.

Another preferred embodiment according to the invention provides a unified transceiver structure having a transceiver operative in a plurality of communications modes. According to this particular embodiment of the invention, the unified transceiver structure comprises a plurality of radio systems, a transmitter and receiver respectively transmitting and receiving signals, and a bandpass filter respectively blocking and suppressing out-of-band signals of the transmitted and received signals, wherein an operative radio system is selected out of the plurality of radio systems. The unified transceiver structure further provides a baseband system programming the transceiver for controlling the transmitter and receiver, and selecting components in the transmitter and receiver for operating the transceiver, in response to the selected operative radio system, and a mode selector selecting an operative communications mode out of the communications modes in response to the selected operative radio system for operating the transceiver.

A further embodiment of the unified transceiver structure according to the invention further comprises a mixer for converting the received signals into baseband signals in an I channel and a Q channel. The unified transceiver structure according to the invention can further comprise a phase shifter for separating the baseband signals into in-phase signals and quadrature phase signals. Moreover, the unified transceiver structure according to the invention can also comprise a phase lock loop for phase locking the baseband signals. Another embodiment of the unified transceiver structure according to the invention further comprises a frequency synthesizer for controlling the frequencies of the baseband signals. The unified transceiver structure according to the invention can further comprise a variable low pass filter (VLPF) respectively rejecting alias signals from the baseband signals in the I and Q channels that are outside the Nyquist frequency. Moreover, the unified transceiver structure according to the invention further comprises an automatic gain control for controlling a variable gain of the baseband signals in the I and Q channels. Yet another embodiment of the unified transceiver structure according to the invention further comprises an analog-to-digital converter (ADC) for digitizing the baseband signals in the I and Q channels for further processing in a baseband system. Furthermore, a variable gain amplifier can further be included in the unified transceiver structure according to the invention for amplifying the baseband signals in the I and Q channels. An additional embodiment of the unified transceiver structure according to the invention further comprises a local oscillator for designating a locally oscillating (LO) settling time for the baseband signals in the I and Q channels in response to a hopping rate of the selected operative communications mode. A switch can be further included in the unified transceiver structure according to the invention for switching back and forth between the transmitter and the receiver, wherein a shortest switching time is selected therefor.

The unified transceiver structure according to another embodiment of the invention further comprises an additional mixer for converting the transmitted signals into baseband signals in an I channel and a Q channel, an additional variable low pass filter (VLPF) reconstructing the baseband signals in the I and Q channels and rejecting out-of-channel signals therefrom, and a baseband amplifier amplifying the baseband signals in the I and Q channels. The unified transceiver structure according to yet another embodiment of the invention can further comprise an in-phase mixer and a quadrature phase mixer respectively up-converting the baseband signals in the I and Q channels into radio frequency (RF) signals, an additional phase shifter separating the baseband signals into in-phase signals and quadrature phase signals, a radio frequency (RF) combiner combining the in-phase and quadrature phase signals. The unified transceiver structure according to this embodiment of the invention can further comprise an additional variable gain amplifier (VGA) controlling a variable gain of the baseband signals in the I and Q channels, an additional bandpass filter (BPF) bandpass filtering the baseband signals, a power amplifier (PA) amplifying the filtered baseband signals, a power detector detecting a radio frequency (RF) power level of the amplified baseband signals and converting the RF power level into a direct current (DC) voltage, and a power monitor monitoring output power of the amplified baseband signals using the DC voltage. The unified transceiver structure can further comprise an additional analog-to-digital converter (ADC) for digitizing the power output of the amplified baseband signals.

Another preferred embodiment of the invention generally provides a communications device for integrating a plurality of radio systems in a unified transceiver structure wherein the radio systems are respectively conformed to a plurality of communications modes with corresponding communications standards. The communications device according to this particular embodiment comprises a baseband system for signal processing, an interface connected to the baseband system, an antenna, a bandpass filter (BPF) connected to the antenna, a switch transmitting and receiving radio frequency (RF) signals from the antenna wherein the transmitted RF signals pass through the switch if said baseband system is in a transmitting mode, and the received RF signals pass through the switch if the baseband system is in a receiving mode, and a radio frequency (RF) transceiver located between the switch and the interface.

The RF transceiver according to this preferred embodiment of the invention further comprises a receiver comprising a first-stage amplifier and filter, down-converters, a second-stage amplifier and filter respectively operable in response to an operative radio system selected from the plurality of radio systems, a transmitter comprising a first-stage amplifier and filter, up-converters, a combiner, a second-stage amplifier and filter respectively operable in response to the selected operative radio system. In a further embodiment of the communications device according to the invention, the bandpass filter (BPF) rejects out-of-band signals from the received RF signals in the receiving mode, whereas the BPF rejects out-of-channel signals from the transmitted signals in the transmitting mode. The receiver in the communications device according to the invention can further comprise a low noise amplifier for low-noise amplifying the received signals. The communications device according to the invention can further comprise a plurality of gain modes determined in accordance with one selected from said communications modes, where the gain modes are stored in the baseband system. The low noise amplifier is respectively operable in response to the gain modes, where each of the gain modes defines a gain value for the low noise amplifier and a threshold respectively responsive to a signal level of the received signals. Another embodiment of the communications device according to the invention further comprises an automatic gain control for determining the threshold and setting the gain value for designating a locally oscillating (LO) settling time. The receiver of the communications device according to the invention can further comprise a mixer for down-converting the received signals into baseband signals. Otherwise, the receiver in the communications device according to the invention can further comprise an in-phase mixer and a quadrature mixer connected in parallel thereto for down-converting the received signals into baseband signals. Yet another embodiment of the receiver in the communications device according to the invention further comprises a variable low pass filter (VLPF), and a variable gain amplifier (VGA) whose channel bandwidths are selected among the plurality of communications standards for preventing in-band gain reduction, where the in-band gain is controlled by the baseband system. The communications device according to the invention can further comprise an in-phase variable bandwidth low pass filter and a quadrature phase variable bandwidth low pass filter. An additional embodiment of the receiver in the communications device according to the invention further comprises a mixer rejecting alias signals from the received signals outside a channel bandwidth for one selected from the plurality of communications modes, and a variable low pass filter (VLPF) receiving input signals from the mixer and outputting filtered baseband signals to the baseband system. The VLPF is variably operable at a cut-off frequency for compliance with different channel bandwidths selected for preventing in-band gain reduction, where the in-band gain is controlled by the baseband system.

In addition, the RF transceiver according to yet another preferred embodiment of the invention further comprises a transmitter comprising a variable bandwidth low-pass filter (VLPF) receiving analog baseband signals from the baseband system for rejecting out-of-channel signals from the baseband signals, where the VLPF is variably operable at a cut-off frequency for compliance with different channel bandwidths in the baseband system that generates a voltage to the VLPF for controlling the channel bandwidths. The communications device according to this preferred embodiment of the invention further comprises an in-phase variable bandwidth low pass filter and a quadrature phase variable bandwidth low pass filter. The communications device according to the invention can further comprise an in-phase baseband amplifier and a quadrature phase baseband amplifier. The transmitter of the communications device according to the invention further comprises a mixer for up-converting the transmitted signals into RF signals. A further embodiment of the transmitter of the communications device according to the invention further comprises an in-phase mixer corresponding to an in-phase baseband amplifier, and a quadrature phase mixer corresponding to a quadrature phase baseband amplifier. The communications device according to the invention can further comprise a variable gain amplifier (VGA) and a power amplifier (PA), where the variable gain amplifier (VGA) provides a variable gain for output power control and the baseband system generates a signal to the VGA for controlling an amplifier gain thereof. The bandpass filter (BPF) can be a harmonic-suppressing BPF suppressing harmonics generated from the VGA, the in-phase mixer and the quadrature phase mixer. The communications device according to the invention can further comprise a phase shifter and a frequency synthesizer for respectively providing a frequency to the in-phase mixer and the quadrature phase mixer through the phase shifter. An additional embodiment of the communications device further comprises an input divider counter and a reference divider counter in the frequency synthesizer for respectively adjusting the frequency provided to the in-phase mixer and the quadrature phase mixer by dividing ratios stored in a table in the baseband system. A yet additional embodiment of the communications device further comprises a local oscillator for respectively generating a locally oscillating (LO) signal for down-converting the received signals and up-converting the transmitted signals, and for selecting a locally oscillating (LO) settling time in response to a hopping rate of one selected from the plurality of communications modes.

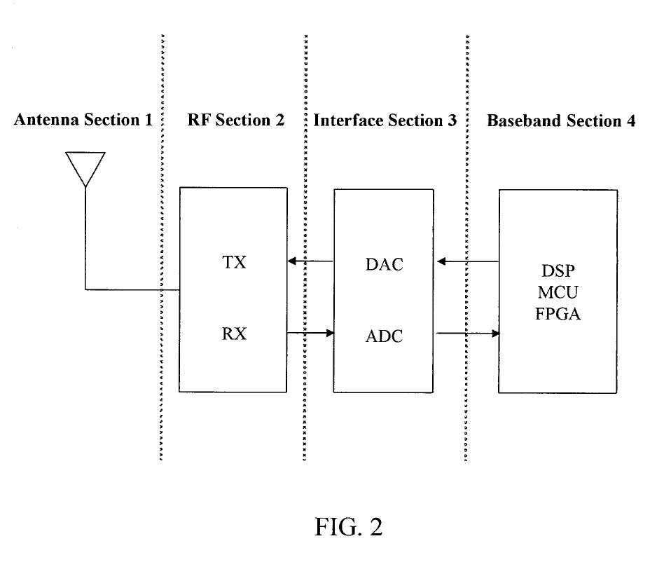

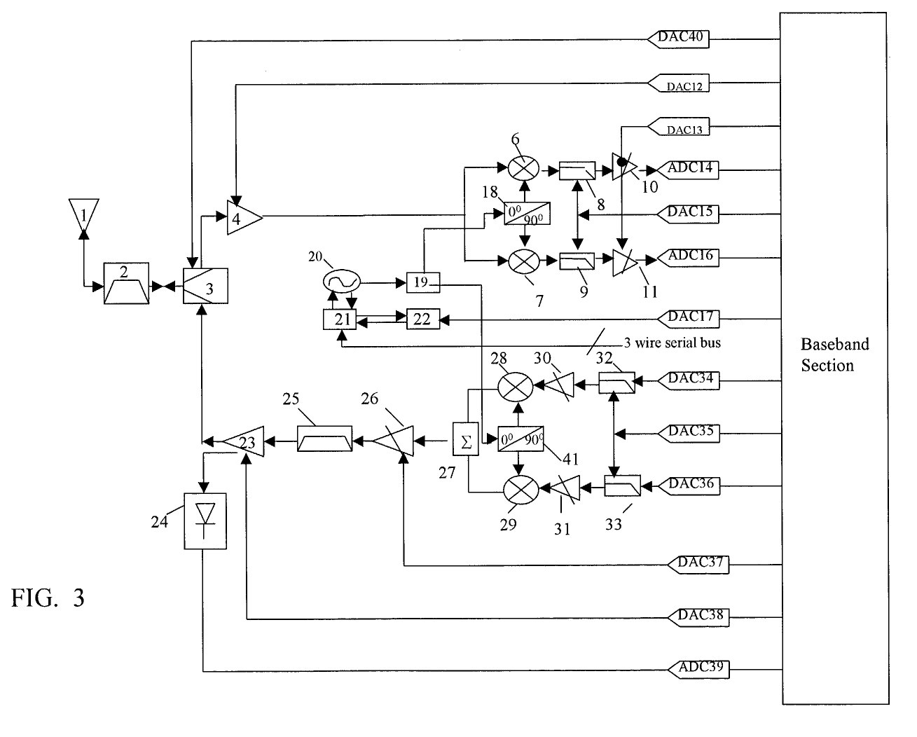

FIG. 2 is a schematic view generally illustrating various sections of a transceiver structure according to an embodiment of the invention. FIG. 3 is another schematic view illustrating a multi-mode transceiver structure according to a preferred embodiment of the invention. Referring to FIGS. 2 and 3, a radio frequency (RF) transceiver is suitably operable for multiple communications modes, which comprises a zero-IF homodyne transmitter and receiver. However, the invention is not confined to the scope and spirit of the RF transceiver illustrated in FIGS. 2 and 3. Other types of transceivers, such as a bi-directional conversion-type heterodyne transceiver, are similarly applicable and operable with the invention.

The RF transceiver in this particular embodiment of the invention is applicable for use in spread spectrum communications in the 2.4 GHz ISM band. Referring to FIG. 2, a baseband section 4 is provided for processing digital signals, which include a physical layer and upper layers. An interface section 3 is provided for digital-to-analog signal conversion (and vice versa). A radio frequency (RF) section 2 is provided for merging the I and Q channels, channel filtering, up-conversion, and power amplification in the transmission mode. In the receiving mode, RF section 2 provides signal amplification, down-conversion, channel filtering, I and Q channel generation. An antenna section 1 is provided for transmitting and receiving signals between RF section 2 and the transmission medium.

For different communications systems in the art, even when they share the same architecture and radio band (e.g., WLAN, Bluetooth™), they still use different radio frequency (RF), interface and baseband sections. The invention advantageously provides one single RF, sampling and baseband section for supporting multi-mode communications.

Referring to FIG. 3, an antenna 1 is connected to a band-select bandpass filter 2 for rejecting out-of-band RF signals outside the 2.4 GHz ISM band. The band-select bandpass filter 2 is connected to an RF switch 3 that allows the filtered transmitted RF signals and the filtered received RF signals to pass through. An analog voltage generated from a digital-to-analog converter (DAC) 40 is applied to the RF switch 3. The RF switch 3 is connected to the input of a low noise amplifier (LNA) 4 and to the output of a power amplifier (PA) 23.

In the receiving mode, the received RF signals are amplified by the LNA 4, i.e., through a first stage low-noise amplification. The LNA 4 includes two gain modes, i.e., a high-gain mode and a low-gain mode. When the receiver RF signal level is lower than one predetermined threshold, the LNA 4 is kept in high-gain mode to provide enough gain. When the receiver RF signal level is higher than another predetermined threshold, the LNA 4 is switched into the low-gain mode to prevent the amplifier from being saturated. The two-gain-mode LNA 4 extends the receiver dynamic range considering the in-door operating environment. Although, the number of the gain mode is confined by two, other suitable number may be used in the present invention. A DAC 12 is used to control the gain mode of LNA 4. The digital RX AGC algorithm in baseband system determines the threshold for LNA 4 gain selection.

The output of LNA 4 is connected to the in-phase (I) mixer 6 and quadrature phase (Q) mixer 7 separately down-converting the receiver RF signal into baseband signal in both I-channel and Q-channel. The phase shifter 18 separates the local oscillated (LO) signal into the in-phase LO signal feeding the mixer 6 and the quadrature phase LO signal feeding the mixer 7.

Moreover, the RF transceiver comprises a frequency synthesizer used to provide a single-tone signal to the mixers 6 and 7/28 and 29 through the phase shifter 18/41. The frequency synthesizer comprises the frequency doubler 19, a local oscillator (LO) 20, a phase lock loop (PLL) 21, a variable loop filter 22 and a DAC 17. The PLL 21 receives the signal from a three-wired series bus. The VLP 22 receives a control signal from DAC 17 and determines the PLL loop bandwidth and LO settling time in response to the control signal. The LO 20 is used to generate a required single tone. Other than controlling the frequency of the local oscillator LO 20, the PLL 21 is used to lock the phase of the LO 20 and the phase of the input signals of the mixers 6 and 7 or the mixers 28 and 29. Therefore, the phase of the frequency signal generated by the LO 20 is synchronously with the phases of the mixers 6 and 7, or the mixers 28 and 29. The LO signal generated by LO 20 is frequency-doubled by the frequency doubler 19. The phase shifter 18 rotates the doubled LO signal through 90 degrees so as to generate an in-phase and a quadrature phase frequency signal to the mixers 6 and 7 for down-converting the receiving signal.

In above structure, the frequency doubler 19 is not a necessary element, however, other configuration that provides a necessary frequency to the mixers can serve the spirit of the present invention.

The output of mixer 6 is connected to the variable bandwidth low-pass filter (VLPF) 8 in I-channel to reject alias signals outside the Nyquist frequency of an analog-to-digital converter (ADC) 14. The output of mixer 7 is connected to the variable bandwidth low-pass filter VLPF 9 in Q-channel to reject alias signals outside the Nyquist frequency of an ADC 16. The VLPF 8 and VLPF 9 are both variable at cut-off frequency to comply different Nyquist frequencies. The DAC 15 generates an analog voltage connected to VLPF 8 and VLPF 9 for controlling the bandwidth of VLPF 8 and VLPF 9.

The I-channel variable-gain amplifier (VGA) 10 is connected to the output of VLPF 8 for amplifying a baseband signal. In addition to the gain selectable in LNA 4, the VGA 10 provides a wider continually variable gain range controlled by the RX AGC algorithm or circuit to maintain pre-determined amplitude of I-channel baseband signal before entering to the ADC 14. The Q-channel variable-gain amplifier VGA II is connected to the output of VLPF 9 for amplifying a baseband signal. In addition to the gain selectable in LNA 4, the VGA11 provides a wider continually variable gain range controlled by the RX AGC algorithm or circuit to maintain pre-determined amplitude of Q-channel baseband signal before entering the ADC 16. The DAC 13 generates an analog DC voltage and connects to VGA 10 and VGA 11 to control the amplifier gain of VGA 10 and VGA 11.

The output of VGA 10 is connected to the analog input of the ADC 14. The ADC 14 digitizes the I-channel baseband signal into digital bits for being processed in baseband system. The output of VGA 11 is connected to the analog input of the ADC 16. The ADC 16 digitizes the Q-channel baseband signal into digital bits to be processed in a baseband system.

In the transmitting mode, the output of DAC 34, which converts the I-channel digital bits into an analog baseband signal, is connected to the input of the reconstruction filter VLPF 32. The output of the DAC 36, which converts the Q-channel digital bits into analog baseband signal, connects to the input of the reconstruction filter VLPF 33.

A VLPF 32 reconstructs the I-channel baseband signal generated by DAC 34. The VLPF 32 also rejects the out-of-channel power infinitely repeatedly every sampling rate in DAC 34. The VLPF 33 reconstructs the Q-channel baseband signal generated by DAC 36. The VLPF 33 also rejects the out-of-channel power infinitely repeatedly every sampling rate in DAC 36. The DAC 35 generates an analog voltage and is in connect with the VLPF 32 and VLPF 31 in order to control the bandwidth of the system.

The output of VLPF 32 is connected to the input of an I-channel baseband amplifier AMP 30 to provide a first stage amplifying. The output of VLPF 33 is connected to the Q-channel baseband amplifier AMP 31 to provide the first stage amplifying.

The output of AMP 30 is connected to an in-phase mixer 28 that up-converts the I-channel baseband signal to an RF signal. The output of AMP 31 is connected to the quadrature phase mixer 29 which will up-convert the Q-channel baseband signal to RF signal. The in-phase and quadrature phase RF signal outputted from mixer 28 and mixer 29, respectively, are connected to the RF combiner 27. The phase shifter 41 separates the LO signal, which is frequency-doubled by the doubler 19, into the in-phase LO signal feeding the mixer 28 and the quadrature phase LO signal feeding the mixer 29.

The output of RF combiner 27 is connected to the RF variable gain VGA 26. The VGA 26 provides a variable gain for performing output power control and TX ALC control. The DAC 37 generates an analog DC voltage that is transferred to VGA 26 to control the amplifier gain of VGA 26.

The output of VGA 26 is connected to the harmonic-suppressed bandpass filter (BPF) 25. The BPF 25 suppresses the harmonics of VGA 26, mixers 28 and 29. The output of BPF 25 is connected to the power amplifier PA. The PA 23 boosts the transmitted RF output power with output power ON/OFF control. The DAC 38 generates an analog DC voltage connected to the PA 23 to select the power ON or OFF.

The output of PA 23 is connected to the RF switch 3 and RF power detector DET 24. The RF power detector DET 24 converts the RF power level into DC voltage to monitor the transmitted output power at the output of the PA 23. The DC voltage output of the DET 24 is connected to the ADC 39 for converting the output power level to digital bits.

In the embodiment of the present invention, the receiver in the RF section of the communication module having one LNA, one I-channel VGA, Q-channel VGA, one I-channel VLPF and one Q-channel VLPF. However, in practice, it is not limited to construct a receiver by only one LNA, one I-channel VGA, Q-channel VGA, one I-channel VLPF and one Q-channel VLPF. Simultaneously, it is not limited to construct the transmitter by only one PA, one BPF, one VGA, one I-channel baseband amplifier AMP, one Q-channel baseband amplifier AMP, one I-channel VLPF and one Q-channel VLPF.

Moreover, in the embodiment of the present invention, the receiver is constructed by the LNA4, the mixers 6 and 7, the VLPF 8 and 9 and the VGA 10 and 11 in sequence from the end connected to the switch 3 to the end connected to the baseband system. Nevertheless, in practice, it is not limited to arrange the components of the receiver in the order mentioned above. Furthermore, in the embodiment of the present invention, the transmitter is constructed by the VLPF 32 and 33, the AMP 30 and 31, the mixers 28 and 29, the combiner 27, the VGA 26, the BPF 25 and the PA 23 in sequence from the end connected to the baseband system to the end connected to the switch 3. However, in practice application, it is not limited to arrange the components of the transmitter in the order described above. Furthermore, although there is only one antenna used in the communication system, it is not limited to use only one antenna in practice.

For WLAN and Bluetooth™ systems involve a plurality of operation details in the RF section including channel bandwidth, hopping rate, hopping (channel) location, receiver (RX) AGC control, transmitter (TX) ALC control, burst shaping (in the time domain), pulse shaping (in the frequency domain), and TX/RX control (with respect to switching time). In accordance with an exemplary RF architecture according to the invention, for multi-mode operation, the channel bandwidth of baseband I/Q VGA, AMP and VLPF is defined to be the widest among the multi-modes standards for preventing in-band gain reduction. For the WLAN 802.11b standard, the baseband I/Q 3-db attenuation bandwidth is about 5.5 to 7.5 MHz. For Bluetooth™, the baseband I/Q 3-db attenuation bandwidth is about 550 to 750 kHz. A method is using a tunable VLPF to control the channel bandwidth. The channel bandwidth is chosen to be able to operate for the widest one, i.e., 7.5 MHz. For operation in Bluetooth™, the cut-off frequency of VLPF 10, VLPF 11, VLPF 32, and VLPF 33 are adjusted to a range from 550 kHz to 750 kHz.

Due to different hoping rates, a fastest or a tunable hopping rate is adapted to suit for multi-modes. Due to the multiple accesses of FHSS, the data packets in a certain channel connection are distributed to the specified frequency channels that hop randomly in band. The LO settling time determines a hopping speed. The LO settling time is designed to be able to operate for the shortest one, i.e., 220 μs, for Bluetooth™ operation mode and is increased by reducing the bandwidth of a variable bandwidth loop filter 22 in PLL synthesizer 21 for lower phase noise and spur performance in DSSS system.

The channel frequency is set and adjusted by programming the input divider counter and reference divider counter in PLL synthesizer 21 by different dividing ratios stored in a table. Tables of programmable registers are stored in PLL synthesizers via the 3-wire or 1²C bus.

The RX AGC is used to maintain a desired envelope of RX I- and Q-channel baseband signal in front of ADC for the best conversion accuracy. The widest dynamic range and the finest resolution of RX AGC can meet the minimum sensitivity level among all standards. For FHSS and TDMA systems, the RX AGC settling time should be the shortest one to avoid the loss of the leading data in packets.

The TX ALC is used to maintain a desired transmission output power level at the output terminal of PA. The widest dynamic range and the finest resolution of TX ALC can meet the requirement of output power control among all standards. For FHSS and TDMA systems, the TX ALC settling time should be the shortest to avoid the power variation of the leading data in packets.

In FHSS and TDMA systems, the data packets are transmitted in power bursts. In time domain, the burst shape indicates the rising and falling time as well as overshoots and damping. A table stores different time-constant values to adjust the burst shape in time domain to meet the timing and CCDF requirements among all standards. Analog low-pass filter with a variable cut-off frequency is used in the RF section. Operated in half-duplex system, the TX/RX control switch the RF signal between TX and RX ports to antenna port, as well as enable or disable the TX and RX power supply for power saving. The switching time should be able to operate for the shortest among all standards.

In the aforementioned detailed description, the WLAN and Bluetooth™ are described as exemplary communications systems operable with the invention. However, the invention may be sinmlarly applicable in other wireless communications systems.

It would be apparent to one skilled in the art that the invention can be embodied in various ways and implemented in many variations. Such variations are not to be regarded as a departure from the spirit and scope of the invention. In particular, the process steps of the method according to the invention will include methods having substantially the same process steps as the method of the invention to achieve substantially the same results. Substitutions and modifications have been suggested in the foregoing Detailed Description, and others will occur to one of ordinary skill in the art. All such modifications as would be obvious to one skilled in the art are intended to be included within the scope of the following claims and their equivalents.

We claim:

1. A method for integrating a plurality of radio systems in a unified transceiver structure having a transceiver operative in a plurality of communications modes, the method comprising the steps of:
transmitting and receiving signals respectively using a transmitter and a receiver;
filtering said transmitted signals and said received signals;
respectively blocking and suppressing out-of-band signals of said transmitted signals and said received signals;
selecting an operative radio system out of said radio systems;
programming said transceiver for controlling said transmitter and said receiver in response to said selected operative radio system;
selecting components in said transmitter and said receiver for operation thereof in response to said selected operative radio system; and
selecting an operative communications mode out of said communications modes in response to said selected operative radio system for operating said transceiver.

2. The method of claim 1 further comprising the step of converting said received signals into baseband signals in an I channel and a Q channel.

3. The method of claim 2 further comprising the step of separating said baseband signals into in-phase signals and quadrature phase signals.

4. The method of claim 2 further comprising the step of phase locking said baseband signals.

5. The method of claim 2 further comprising the step of controlling frequencies of said baseband signals.

6. The method of claim 2 further comprising the step of respectively selecting channel bandwidths for said I channel and Q channel of said baseband signals.

7. The method of claim 2 further comprising the step of respectively rejecting alias signals from said baseband signals in said I channel and said Q channel that are outside a Nyquist frequency.

8. The method of claim 2 further comprising the step of controlling a variable gain of said baseband signals in said I channel and said Q channel.

9. The method of claim 2 further comprising the step of digitizing said baseband signals in said I channel and said Q channel for processing in a baseband system.

10. The method of claim 2 further comprising the step of preventing in-band gain reduction by controlling a variable gain of, and rejecting alias signals from, said baseband signals in said I channel and said Q channel, respectively.

11. The method of claim 2 further comprising the step of conforming to said selected operative radio system by respectively selecting channel bandwidths for, controlling a variable gain of, and rejecting alias signals from said baseband signals in said I channel and said Q channel.

12. The method of claim 1 further comprising the step of tuning a hopping rate for one selected from said communications modes.

13. The method of claim 1 further comprising the step of programming a hopping channel for one selected from said communications modes.

14. The method of claim 2 further comprising the step of designating a locally oscillating (LO) settling time for said baseband signals in said I channel and said Q channel in response to a hopping rate of one selected from said communications modes.

15. The method of claim 1 further comprising the step of maintaining a transmission output power level for one selected from said communications modes.

16. The method of claim 2 further comprising the step of designating a shortest locally oscillating (LO) settling time for said baseband signals in said I channel and said Q channel for maintaining a transmission output power level for one selected from said communications modes.

17. The method of claim 2 further comprising the step of adjusting a burst shape of said baseband signals in time domain.

18. The method of claim 17 further comprising the step of controlling rising and falling time, overshoots and damping of said burst shape.

19. The method of claim 1 further comprising the step of switching between said transmitter and said receiver.

20. The method of claim 19 further comprising the step of selecting a shortest switching time for said switching step.

21. The method of claim 1 further comprising the step of converting said transmitted signals into baseband signals in an I channel and a Q channel.

22. The method of claim 2 further comprising the step of respectively reconstructing said baseband signals in said I channel and said Q channel.

23. The method of claim 2 further comprising the step of respectively rejecting out-of-channel signals from said baseband signals in said I channel and said Q channel.

24. The method of claim 2 further comprising the step of respectively controlling channel bandwidths for said I channel and said Q channel of said baseband signals.

25. The method of claim 2 further comprising the step of respectively up-converting said baseband signals in said I channel and said Q channel into radio frequency (RF) signals.

26. The method of claim 2 further comprising the step of separating said baseband signals into in-phase signals and quadrature phase signals.

27. The method of claim 26 further comprising the step of radio frequency (RF) combining said in-phase signals and said quadrature phase signals.

28. The method of claim 2 further comprising the step of controlling a variable gain of said baseband signals in said I channel and said Q channel.

29. The method of claim 2 further comprising the steps of:
bandpass filtering said baseband signals in said I channel and said Q channel; and
power amplifying said filtered baseband signals.

30. The method of claim 29 further comprising the steps of:
detecting a radio frequency (RF) power level of said amplified baseband signals;
converting said RF power level into a direct current (DC) voltage; and
monitoring output power of said amplified baseband signals using said DC voltage.

31. A unified transceiver structure having a transceiver operative in a plurality of communications modes, the structure comprising:
a plurality of radio systems;
a transmitter and receiver respectively transmitting and receiving signals;
a bandpass filter respectively blocking and suppressing out-of-band signals of said transmitted signals and said received signals;
wherein an operative radio system is selected out of said radio systems;
a baseband system programming said transceiver for controlling said transmitter and said receiver, and selecting components in said transmitter and said receiver for operating said transceiver, in response to said selected operative radio system; and
a mode selector selecting an operative communications mode out of said communications modes in response to said selected operative radio system for operating said transceiver.

32. The structure of claim 31 further comprising a mixer for converting said received signals into baseband signals in an I channel and a Q channel.

33. The structure of claim 32 further comprising a phase shifter for separating said baseband signals into in-phase signals and quadrature phase signals.

34. The structure of claim 32 further comprising a phase lock loop for phase locking said baseband signals.

35. The structure of claim 32 further comprising a frequency synthesizer for controlling frequencies of said baseband signals.

36. The structure of claim 32 further comprising a variable low pass filter (VLPF) respectively rejecting alias signals from said baseband signals in said I channel and said Q channel that are outside a Nyquist frequency.

37. The structure of claim 32 further comprising an automatic gain control (AGC) for controlling a variable gain of said baseband signals in said I channel and said Q channel.

38. The structure of claim 32 further comprising an analog-to-digital converter (ADC) for digitizing said baseband signals in said I channel and said Q channel for processing in a baseband system.

39. The structure of claim 32 further comprising a variable gain amplifier (VGA) for amplifying said baseband signals in said I channel and said Q channel.

40. The structure of claim 32 further comprising a local oscillator for designating a locally oscillating (LO) settling time for said baseband signals in said I channel and said Q channel in response to a hopping rate of one selected from said communications modes.

41. The structure of claim 31 further comprising an additional mixer for converting said transmitted signals into baseband signals in an I channel and a Q channel.

42. The structure of claim 41 further comprising an additional variable low pass filter (VLPF) reconstructing said baseband signals in said I channel and said Q channel and rejecting out-of-channel signals therefrom.

43. The structure of claim 41 further comprising a baseband amplifier amplifying said baseband signals in said I channel and said Q channel.

44. The structure of claim 41 further comprising an in-phase mixer and a quadrature phase mixer respectively up-converting said baseband signals in said I channel and said Q channel into radio frequency (RF) signals.

45. The structure of claim 41 further comprising an additional phase shifter separating said baseband signals into in-phase signals and quadrature phase signals.

46. The structure of claim 45 further comprising a radio frequency (RF) combiner combining said in-phase signals and said quadrature phase signals.

47. The structure of claim 41 further comprising an additional variable gain amplifier (VGA) controlling a variable gain of said baseband signals in said I channel and said Q channel.

48. The structure of claim 41 further comprising:
an additional bandpass filter (BPF) bandpass filtering said baseband signals in said I channel and said Q channel; and
a power amplifier (PA) amplifying said filtered baseband signals.

49. The structure of claim 48 further comprising:
a power detector detecting a radio frequency (RF) power level of said amplified baseband signals and converting said RF power level into a direct current (DC) voltage; and
a power monitor monitoring output power of said amplified baseband signals using said DC voltage.

50. The structure of claim 49 further comprising an additional analog-to-digital converter (ADC) for digitizing said power output of said amplified baseband signals.

51. A communications device for integrating a plurality of radio systems in a unified transceiver structure wherein the radio systems are respectively conformed to a plurality of communications modes with corresponding communications standards, the communications device comprising:
a baseband system for signal processing;
an interface connected to said baseband system;
an antenna;
a bandpass filter (BPF) connected to said antenna;
a switch transmitting and receiving radio frequency (RF) signals from said antenna wherein said transmitted RF signals pass through said switch if said baseband system is in a transmitting mode, and said received RF signals pass through said switch if said baseband system is in a receiving mode;
a radio frequency (RF) transceiver located between said switch and said interface wherein said RF transceiver further comprises:
a receiver comprising a first-stage amplifier and filter, down-converters, a second-stage amplifier and filter respectively operable in response to an operative radio system selected from said radio systems;
a transmitter comprising a first-stage amplifier and filter, up-converters, a combiner, a second-stage amplifier and filter respectively operable in response to said selected operative radio system.

52. The communications device of claim 51 wherein said bandpass filter (BPF) rejects out-of-band signals from said received RF signals in said receiving mode, and said BPF rejects out-of-channel signals from said transmitted signals in said transmitting mode.

53. The communications device of claim 51 wherein said receiver further comprises a low noise amplifier for low-noise amplifying said received signals.

54. The communications device of claim 53 further comprising a plurality of gain modes determined in accordance with one selected from said communications modes wherein said gain modes are stored in said baseband system, and said low noise amplifier is respectively operable in response to said gain modes, each of said gain modes defining a gain value for said low noise amplifier and a threshold respectively responsive to a signal level of said received signals.

55. The communications device of claim 54 further comprising an automatic gain control for determining said threshold and setting said gain value for designating a locally oscillating (LO) settling time.

56. The communications device of claim 51 wherein said receiver further comprises a mixer for down-converting said received signals into baseband signals.

57. The communications device of claim 51 wherein said receiver further comprises an in-phase mixer and a quadrature mixer connected in parallel thereto for down-converting said received signals into baseband signals.

58. The communications device of claim 51 wherein said receiver further comprises:
a variable low pass filter (VLPF); and
a variable gain amplifier (VGA) whose channel bandwidths are selected among said communications standards for preventing in-band gain reduction wherein said in-band gain is controlled by said baseband system.

59. The communications device of claim 58 further comprising an in-phase variable bandwidth low pass filter and a quadrature phase variable bandwidth low pass filter.

60. The communications device of claim 51 wherein said receiver further comprises
a mixer rejecting alias signals from said received signals outside a channel bandwidth for one selected from said communications modes; and
a variable low pass filter (VLPF) receiving input signals from said mixer and outputting filtered baseband signals to said baseband system wherein said VLPF is variable at a cut-off frequency for compliance with different channel bandwidths selected for preventing in-band gain reduction;
wherein said in-band gain is controlled by said baseband system.

61. The communications device of claim 51 wherein said transmitter further comprises a variable bandwidth low-pass filter (VLPF) receiving analog baseband signals from said baseband system for rejecting out-of-channel signals from said baseband signals wherein said VLPF is variable at a cut-off frequency for compliance with different channel bandwidths in said baseband system that generates a voltage to said VLPF for controlling said channel bandwidths.

62. The communications device of claim 61 further comprising an in-phase variable bandwidth low pass filter and a quadrature phase variable bandwidth low pass filter.

63. The communications device of claim 51 further comprising:
a variable low pass filter; and
a baseband amplifier having a bandwidth selected among said communications standards for preventing in-band gain reduction.

64. The communications device of claim 51 further comprising an in-phase baseband amplifier and a quadrature phase baseband amplifier.

65. The communications device of claim 51 wherein said transmitter further comprises a mixer for up-converting said transmitted signals into RF signals.

66. The communications device of claim 51 wherein said transmitter further comprises an in-phase mixer corresponding to an in-phase baseband amplifier, and a quadrature phase mixer corresponding to a quadrature phase baseband amplifier.

67. The communications device of claim 51 further comprising a variable gain amplifier (VGA) and a power amplifier (PA).

68. The communications device of claim 67 wherein said variable gain amplifier (VGA) provides a variable gain for output power control, and said baseband system generates a signal to said VGA for controlling an amplifier gain thereof.

69. The communications device of claim 66 further comprising a variable gain amplifier (VGA) wherein said bandpass filter (BPF) is a harmonic-suppressing BPF suppressing harmonics generated from said VGA, said in-phase mixer and said quadrature phase mixer.

70. The communications device of claim 66 further comprising a phase shifter and a frequency synthesizer for respectively providing a frequency to said in-phase mixer and said quadrature phase mixer through said phase shifter.

71. The communications device of claim 70 further comprising an input divider counter and a reference divider counter in said frequency synthesizer for respectively adjusting said frequency provided to said in-phase mixer and said quadrature phase mixer by dividing ratios stored in a table in said baseband system.

72. The communications device of claim 51 further comprising a local oscillator for respectively generating a locally oscillating (LO) signal for down-converting said received signals and up-converting said transmitted signals, and for selecting a locally oscillating (LO) settling time in response to a hopping rate of one selected from said communications modes.

73. The communications device of claim 51 further comprising a mixer for converting said received signals into baseband signals in an I channel and a Q channel.

74. The communications device of claim 73 further comprising a frequency synthesizer for controlling frequencies of said baseband signals.

75. The communications device of claim 73 further comprising an automatic gain control for controlling a variable gain of said baseband signals in said I channel and said Q channel.

76. The communications device of claim 73 further comprising a local oscillator for designating a locally oscillating (LO) settling time for said baseband signals in said I channel and said Q channel in response to a hopping rate of one selected from said communications modes.

77. The communications device of claim 51 further comprising an additional mixer for converting said transmitted signals into baseband signals in an I channel and a Q channel.

78. The communications device of claim 77 further comprising an additional phase shifter separating said baseband signals into in-phase signals and quadrature phase signals.

79. The communications device of claim 78 further comprising a radio frequency (RF) combiner combining said in-phase signals and said quadrature phase signals.

80. The communications device of claim 77 further comprising an additional variable gain amplifier (VGA) controlling a variable gain of said baseband signals in said I channel and said Q channel.
